(19) United States
(12) Patent Application Publication
(10) Pub. No.: US 2014/0031000 A1
(43) Pub. Date: Jan. 30, 2014

(54) METHOD FOR EMERGENCY SIGNALING VIA MOBILE TELECOMMUNICATIONS DEVICE

(71) Applicant: Frederick Hanover, Columbus, OH (US)

(72) Inventor: Frederick Hanover, Columbus, OH (US)

(73) Assignee: RAMPART HOSTING, Columbus, OH (US)

(21) Appl. No.: 13/744,636

(22) Filed: Jan. 18, 2013

Related U.S. Application Data
(63) Continuation of application No. 13/270,014, filed on Oct. 10, 2011, now abandoned.

(51) Int. Cl. H04W 4/22

(52) U.S. Cl. CPC H04W 4/22
USPC 455/404.2; 455/404.1

(57) ABSTRACT

Emergency call placement methods and apparatus for a mobile telecommunications device in a wireless network are disclosed. The method includes detecting a initiation interaction from a user during a ready mode of the mobile telecommunications device, determining the state of allowed communication based on predetermined user preferences, initiating an alert mode, signaling a remote emergency services call center, determining the position of the mobile telecommunications device, sending the position of the mobile telecommunications device to the emergency services call center. The initiation interaction can be, for example, a predetermined number of taps of a touch screen. This method allows the security center to use a location methodology to locate the user in response to the emergency call. The described mobile telecommunications device is configured to implement the disclosed method, optionally via a downloadable application.

### CROSS-REFERENCE TO RELATED APPLICATIONS

This non-provisional patent application claims the benefit of U.S. Provisional Application No. 61/473,001 filed on 7 Apr. 2011, the content of which is hereby incorporated by reference as if fully recited herein in its entirety.

### TECHNICAL FIELD

The present application is in the field of emergency signaling and more particularly in the field of signaling for emergency services via mobile telecommunications device.

### BACKGROUND

With the advent of cell or mobile telecommunications device technology, people throughout the world can now communicate with anyone on the planet from almost any geographic location near a cell or mobile phone tower. Current cell phone technology allows for the storage of data (such as contact information), to-do lists, and appointments and schedules. Cell phones also serve as a mini-computer system, can send and receive electronic mail, can send and receive video and audio signals, can access the Internet, can act as a gaming system, and can also be integrated with other electronic equipment (such as, for example, tablets, personal digital assistants, MP3 players, laptops, computer systems, global positioning receivers, and like mobile telecommunications devices).

The foundation of a cellular phone system is based upon the division of a geographic area into “cells”. Such a division allows extensive frequency or spectrum reuse across the geographic region, thereby allowing theoretically millions of people to use their cell phones simultaneously. Carrier typically divide a geographic location into cells, and place multiple cellular towers to cover smaller portions of the geographic location. Each cellular tower can be sized to cover approximately 10 square miles, and each cell is typically defined as hexagons on a big hexagonal grid (although the tower's signal transmission is radial in scope). Of course, the signal strength of each cell tower may be adjusted for geographic location (e.g., a strong signal may be needed for rural Iowa which may not have many cellular towers, and a weak signal may be needed for urban New York city, where the population is dense). Each cellular tower has a base station (or, base transceiver station) that consists of a tower and a corresponding small housing containing a power source and communication/radio equipment which is in communication with other cellular towers, the cell phone carrier's computer and communication equipment, and the Internet as well. Because cell phones and base stations use low-power transmitters, the same frequencies can be reused in non-adjacent cells within the geographic area.

Each carrier in each geographic area also runs one or more central offices called the Mobile Telephone Switching Office (MTSO), which communicates with each cell tower/base station in the geographic area through one or more MTSO computer and communication systems. The acronym “MTSO” is a term that was commonly used in the communications industry, but which is now commonly referred to as the mobile switching center (MSC). As defined in this disclosure, the phrase “public land mobile network” (“PLMN”) will be used to represent the entire mobile telecommunications device communication network, regardless of the type of technology used in the communication network (e.g., GSM, PCS, CDMA, UMTS, etc). The PLMN computer and communication systems handles all of the phone connections from the cellular towers to other cellular towers, and also connections from a cellular tower to the normal land-based phone system, and controls all of the base stations in the region (whether inter-carrier or intra-carrier). While the term “cell” or “cellular” is used herein to refer to certain type of mobile telecommunications device communication protocols, this term is used in its broadest sense, and therefore, includes technology covered by personal communications service (“PCS”) protocol, and the Global System for Mobile communications (“GSM”) protocol as is common in Europe and the like.

Generally, the type of electronic, computer and communication systems used by PLMN networks for cell phone communication vary in scope, but in general, the PLMN networks have at a minimum, one or more computer servers that can control communication signals to and from mobile telecommunications devices, can store and access databases full of contact information, include hardware and software that can hold messages for direction to the correct recipients, include storage drives for archiving messages and replies, and include software that can analyze and record responses to messages and encryption tools for use when handling sensitive information.

It is well known in the art that cell phones are full duplex devices, which means that based on multiple communication frequency technologies and frequency shifting techniques, the cellular communication may theoretically allow for each person in the communication string to talk at once. A typical cell phone can communicate on up to 1,663 frequencies (or, channels), and more are contemplated. Because cell phones operate within a cell, such phones can switch cells as the phone is moved between geographic areas, thereby giving the illusion that the phone has a very wide geographic range of use. This means that (assuming power is available) a cell phone user can move theoretically thousands of miles and maintain a constant communication.

Currently, every cell phone has a pre-determined special code associated with it, which is used to identify the specific phone, the phone's owner and the phone's service provider. Currently, each phone has an Electronic Serial Number (ESN), a Mobile Identification Number (MIN), and a System Identification Code (SID). The ESN is a unique 32-bit number programmed into the phone when it is manufactured. The MIN is currently a 10-digit number derived from the phone's number. The SID is a unique 5-digit number that is assigned to each carrier by the Federal Communication Commissioner (FCC). While the ESN is considered a permanent part of the phone, both the MIN and SID codes are programmed into the phone when the cell phone is activated by a carrier. Moreover, the ESN protocol is now being replaced by Mobile Equipment IDentifier (MEID) codes because the ESN range of codes are becoming depleted The MEID protocol implements 56 bit numbers, and thus, will have a larger number of available codes to accommodate the increasing use of mobile telecommunications devices as compared to twenty years ago when ESN was developed.

When a cell phone is first activated, it transmits a signal seeking the nearest cellular tower/base station. More specifically, the cell phone attempts to receive an SID on at least one control channel. The control channel is a special frequency that the phone and cellular tower/base station use to communicate. If the cell phone cannot find any control channels to listen to, this means that the cell phone is out of range of any cellular tower, and the phone is usually programmed to display a “no service” or similar message. When a cell phone receives the SID from the cellular tower/base station, the phone is programmed to compare the SID signal with the SID number programmed into the phone.

Obviously, most if not all of these seemingly automated functions of the cell phone are performed through software stored in each cell phone. If the two SIDs match, the phone is programmed to know that the cellular system it is communicating with is part of its home system (or, the home carrier's system). Along with the SID, the cell phone is also programmed to transmit a registration request, so that the PLMN can keep track of the cell phone's approximate geographic location in a database. The PLMN network's tracking of the cell phone's geographic location is used mainly to compute which cell phone tower is nearest the cell phone as the cell phone moves, so as to allow for more efficient communication switching when the phone is mobile. Thus, for example, when the PLMN's computer and communication system is notified electronically that an incoming communication for a particular cell phone has arrived, the PLMN's computer and communication system can then locate the particular cell phone in its database, locate the nearest cellular tower, and forward the incoming call to the nearest cellular tower to complete the communication path. As part of this process, the PLMN's network picks a frequency pair that the cell phone will use in that particular cell region to take the call. The PLMN network also communicates with the cell phone over the control channel to control which frequencies to use, and once the cell phone and the nearer tower switch to those frequencies, the call is connected.

This tower location function performed by networks also allows the location of mobile telecommunications devices or cell phones via cellular triangulation. That is, the device's location can be pinpointed by the comparing the relative strength of signal between multiple cellular towers. This can result in a very accurate location depending on the number of cellular towers accessible by the network and the number of mobile telecommunications devices operating at any time.

As the cell phone is moved to the end of a cellular tower's range, the cellular tower's base station notes that the cell phone's signal strength is diminishing. Concurrently, the cellular tower/base station in the cell that the cell phone is moving toward has been in contact with the PLMN's network to let the PLMN computer system know that the cell phone's signal strength is increasing. The two base stations coordinate with each other through the PLMN computer system, and upon a pre-programmed event on the PLMN computer system, the cell phone receives a signal on one or more control channels commanding the mobile telecommunications device to change frequencies corresponding to the new cellular tower (so that the cell phone's communication is handed off from a remotely located base station to a nearer base station). Of course, this process is slightly different if a cell phone moves from one carrier service to another carrier service, but the overall process is basically the same.

Currently, a conventional cell phone housing contains many integrated parts, including a control circuit board (or, computer control system), an antenna, one or more displays such as a liquid crystal display (LCD), a keyboard, a microphone, a power source such as a battery, and a speaker, all in electronic communication with each other. The control circuit board includes, typically, a programmable microprocessor, analog-to-digital and digital-to-analog conversion chips, control amplifiers and storage electronics (such as ROM, RAM, DRAM, EPROM, flash memory, and like electronics), all in communication with one another.

With the further development of cell phone technology, cell phones are now equipped to provide an incredible array of functions, with additional functions being added almost on a daily basis by cell phone manufacturers. Thus, under 3G technology, cell phones are increasingly being made which feature increased bandwidth and transfer rates to accommodate Web-based applications and phone-based audio and video files.

Additionally, a Subscriber Identity Module (SIM) memory card is a common feature in cell phones today. A SIM card is part of a removable smart card which securely stores a service-subscriber key (IMSI) used by a carrier to identify a subscriber. A conventional SIM card allows a cell phone user to change cell phones by simply removing the SIM card from one cell phone and inserting it into another cell phone or broadband telephony device. SIM cards can also be adapted to receive and retain SMS messages or other emergency data (such as, for example, data corresponding to a pre-recorded voice message). SIM cards may also be adapted to achieve any function which requires programmable memory.

As described previously, a cell phone is in almost constant communication with a nearby cellular tower/base station. Even when the cell phone is not activated, the cell phone is programmed to transmit and receive communication signals from the tower/base station over one or more communication paths known as the control channel. In this regard, the carrier's network may then maintain data representing the approximate location of the cell phone in approximately real-time. The control channel is also used for call setup. If an incoming call arises, the cellular tower sends a communication signal over the control channel to control the phone to play a ringtone, and controls the frequencies upon which the communication will take place.

Currently, the Federal Communications Commission (the “FCC”) is advancing location technology that enables emergency services to locate the geographic position of a mobile phone. This technology requirement has become known as Enhanced 911 or E, for short. Different wireless communication systems or Radio Access Technologies (RATs) currently employ different location determination methods in order to effect E911 calls. For example, the Global System for Mobile Communication (i.e., “GSM”) standard and associated systems, although capable of supporting various location methods, typically support Uplink Observed Time Difference of Arrival (i.e., “UTDOA”) for location determination. On the other hand, the more recently deployed Universal Mobile Telephone Standard (i.e., UMTS) or 3GPP specification (G) systems typically support Assisted Global Positioning System (“AGPS”) for location determination.

Moreover, many cellular phones and mobile telecommunications devices are capable of tracking their position by GPS. The devices are in communication with orbital satellites and through this communication, the device is able to receive information from the satellites and calculate a position based on this information. In some instances, a mobile telecommunications device may also track and display the number of GPS satellites it is in communication with and can calculate how accurate the position displayed is. Additionally, some mobile telecommunications devices are currently equipped with altimeters allowing even more enhanced location information.

However, many municipalities lack the equipment and/or funding to utilize these location technologies and will not send responders to a 911 call without a physical address, even when presented with GPS coordinates from a mobile telecommunications device. Thus, there exists a need for a method of providing alert notifications to emergency dispatchers that includes data such as nearest physical address so that an appropriate dispatch of emergency responders can be sent.

Many modern mobile telecommunications devices such as cell phones utilize touch screens for user interface. This touch screen interface allows users to interact in more ways than previously available via conventional assigned task buttons. For example, a user may tap the touch screen of their mobile telecommunications device once to initiate a program/application, or preferences may be established for different motions initiating specific modes for the mobile telecommunications device. Some devices employ specific motions/codes to unlock the device screen in order to access application shortcuts available on the main user screen.

Many mobile telecommunications device applications run or are accessible while the device is powered on, but in an idle or sleep mode. These idle modes allow a user to access applications more quickly than when performing a full boot-up of their mobile telecommunications device from a powered-off state. This coupled with touch screen interactivity allows users access to applications quickly and affords the opportunity to tailor certain screen interaction patterns to access specific applications.

### SUMMARY

This and other unmet needs of the prior art are met by compounds and methods as described in more detail below.

An alert mode of a mobile telecommunications device is activated based on the mobile telecommunications device receiving an initiation interaction. The initiation interaction may be a pattern of taps lines made on a touch screen of the mobile telecommunications device by a user. The alert mode initiates a communication session with a remote call center. The alert mode may enable two-way audio communication, one-way audio communication, one-way audio with corresponding text communication; it may prompt the user for more input such as desired mode of communication or confirmation of the alert mode. The alert mode may enable one-way audio, for example from the mobile telecommunications device to the call center, and also enable touch screen interaction on the mobile telecommunications device for confirmation of an emergency or identification of the source of the emergency prompting the initiation interaction by the user.

For example, the user might encounter an emergency situation such as someone breaking into their domicile. The user then initiates an alert mode of the mobile telecommunications device by performing an initiation interaction. The user may have predetermined that the communication should be one-way audio until confirmation of two-way audio has been received by the mobile telecommunications device, or the user may have predetermined that the alert mode should instruct a security center to dispatch the police immediately among others. If the selection is for one-way communication, the security center can hear via the mobile telecommunications device but cannot communicate audibly. The mobile telecommunications device may then prompt the user for more information about the emergency via predetermined questions, either to confirm an emergency or to determine the nature of the emergency, or alternatively, the application may instruct the device to enter a lock mode and will require a PIN to cancel the alert mode. If a prompt is directed, the prompt may include questions such as “are you in danger” or “can you speak with a representative” which the user may answer using visual prompts that can be selected via the touch screen or other interface capability of the mobile telecommunications device. Or, the alert mode may allow the user to communicate via text message once the alert mode has been initiated or after confirming the user's desire to use text communication allowing the user to remain silent but still provide information to the call center. This mode allows the user to provide more contextual information and to respond more pointedly to inquiries from the call center. This would be particularly useful in the home invasion scenario. The device will also send the position of the mobile telecommunications device to the call center allowing the call center to send appropriate services to the location of the emergency.

Alternatively, the call center may determine the extent of the emergency based on audio from the mobile telecommunications device alone and may send appropriate emergency services to the location without further active confirmation from the user.

Disclosed embodiments describe a computer implemented method for signaling an emergency services call center. The method includes receiving an initiation interaction from a user, determining the state of active communication based on predetermined user preferences, initiating the active communication mode, signaling a remote emergency services call center, determining the position of the mobile telecommunications device, sending the position of the mobile telecommunications device to the security center.

Disclosed embodiments describe a method for transmitting an alert signal of a mobile telecommunications device during an emergency situation, the method including the steps of: receiving an initiation interaction from a user of the device; retrieving a current location of the mobile telecommunications device; determining an alert setting of the device; sending a message from the mobile telecommunications device to a client, initiating a message to a security center, the message comprising the current location of the mobile telecommunications device and the alert setting of the device; providing feedback to the user that the message was sent to the client; and connecting to the security center according to the alert settings of the device after receiving the acknowledgment message from the client.

### BRIEF DESCRIPTION OF THE DRAWINGS

A better understanding of the exemplary embodiments of the invention will be had when reference is made to the accompanying drawings, wherein identical parts are identified with identical reference numerals, and wherein:

FIG. 1 is a flowchart representing the functional modes of an embodiment of the described methods.

FIG. 2 is a flowchart showing functions and decisions in an embodiment of the described methods.

FIG. 3 is a screenshot of a display showing an embodiment of a prompt to set security alert.

FIG. 4 is a screenshot of a display showing an embodiment of a menu of selectable security center actions and descriptions.

FIG. 5 is a screenshot of a display showing an embodiment of Emergency Instructions.

FIG. 6 is a screenshot of a display showing an embodiment of alternative menu options.

FIG. 7 is a screenshot of an embodiment of an interaction icon.

FIG. 8 is a screenshot of a display showing an embodiment of a lock screen.

FIG. 9 is a screenshot of a display showing an embodiment of screen requiring a PIN.

FIG. 10 is a screenshot of a display showing an embodiment of alert options once the screen has been unlocked and the correct PIN entered.

FIG. 11 is a screenshot of a display showing an embodiment of optional emergency contacts.

### DETAILED DESCRIPTION

Disclosed embodiments describe a computer implemented method executable on a mobile telecommunications device (or “device”) such as a cellular phone. Embodiments include a application downloadable from, for example, the Internet onto a mobile telecommunications device capable of accessing global positioning satellite (GPS) information to track the current location of the device.

GPS capable mobile telecommunications devices are currently in wide use, as are the services that allow for designating the devices location via GPS coordinates, cellular triangulation and geo coded street address locations, and corresponding locality determinations currently recognized by first responders. The computer implemented method allows the device to utilize GPS information to verify location, distress and intervention needs.

In an embodiment, the computer implemented method turns a mobile telecommunications device into a mobile security system with the capability to dispatch first responders such as law enforcement, ambulance, fire and rescue forces to a user's GPS/geo coded and/or cellular-triangulated location. The method interfaces with GPS, geo coding, Wi-Fi, G, 4G, Edge cellular etc. networks.

In an embodiment, after an alert signal has been sent by the device, it will be received at a security center over one or more of the aforementioned communication methods. The security center then responds to the user's customizable signal based on the instructions that the user has preselected. These security signal types provide capabilities related towards awareness programs typically, and enhanced versions of various applications within software applications capabilities, such as, but not limited to an enhanced mobile security system which substantially monitors real-time relationships with the applicant to support location respondents in given conditions, resourceful information can be given to family members in declining environments, information monitoring via voice activated signatures can enable responding emergency personnel to keep going forward with operations, designation exactness of routes of travel and survivor ability options could conceivably be calculated. The computer implemented method allows for immediate dispatch of emergency personnel without emergency condition verification—a prerequisite of 911 dispatch. Moreover, 911 responders are only capable of tracking the location of a mobile telecommunications device to its closest cell tower, making accurate location difficult.

Signaling for emergency services e.g. 911 via mobile telecommunications device is a relatively simple matter once the caller is safely away from the emergency situation (e.g. after a car accident or after having escaped from a house fire). Signaling during an ongoing emergency situation, however, is fraught with unpredictable variables and can make placing an emergency services call much more difficult. It is with this in mind that described embodiment provide ease of access to emergency services via mobile telecommunications device with minimal user attention. In an embodiment, a user may signal for help by performing a simple pre-set initiation interaction such as tapping the screen of a touch-screen cellular phone and be connected to a security center ready to signal for help with a current location of the device dramatically reducing response time and requiring little interaction from the user during the emergency situation.

Though many modern mobile telecommunications devices such as cell phones track the location of the device via GPS or cellular triangulation, this information is rarely used to improve responsiveness to an emergency situation. Current EMS responders and 911 dispatch centers will not respond without an address and lack the capability to access GPS positions of mobile telecommunications devices. However, most users when confronted with a dangerous situation do not know their address, may be too panicked to recall, or may feel that audible response might place them in greater danger. The method of the disclosed embodiments provides a GPS signal location or cellular triangulation location to a security center which includes an accuracy range which may then be translated into a physical address for communication with EMS dispatchers (911 for example) to further facilitate the swift arrival of emergency responders.

In an embodiment, the functionality of the method during operation should mimic the functionality of the “silent alarm” common to the banking industry. One rationale behind the silent alarm is to prevent the alert signal from inflaming an already dangerous situation through informing the perpetrator that an alarm has been triggered. The worry is that the perpetrator would become panicked or angry that the alarm has been triggered lowering their chances of a clean getaway and increasing the danger to bystanders or attempting to disarm the alarm. Thus, in an embodiment, the method described herein operates to hide fact that an alert has been triggered and has several unique features preventing detection and/or interference by persons other than the user.

In a preferred embodiment, the method is executed through a computer implemented application downloadable, for example, from the Internet. Once the application is loaded onto the mobile telecommunications device, the application may be started by selecting an icon. Some common methods for selecting icons on mobile telecommunications devices include scrolling with a track-ball until the desired icon is highlighted or tapping the desired icon if the mobile telecommunications device is capable of touch-screen interaction, among other selection types (e.g. audible command, fingerprint swipe).

As used herein the term “Open Mode” refers to a mode of the computer implemented method in which the mobile telecommunications device is set to receive instructions from a user about set-up, preferences or whether or not to enter a Ready Mode. “Ready Mode” refers to a mode of the computer implemented method wherein the mobile telecommunications device is set to receive an initiation interaction from a user, or receive instruction from a user to return to Open Mode. The term “Alert Mode” refers to a mode of the computer implemented method wherein the mobile telecommunications device has received an initiation interaction form a user and is sending messages to clients and performing instructions set by the user. The term “initiation interaction” refers to an interaction received by a user when the device is in Ready Mode. The interaction may include tapping a touch screen of the device a certain number of times, tracing a pattern on a touch screen, entering a PIN, selecting an icon with a track-ball of the device, or providing an audible command etc. Once Alert Mode has been initiated, the alert may be cancelled when the device receives a cancellation protocol. The cancellation protocol may include unlocking the touch screen of the device, entering a PIN, giving an audible command, selecting an icon, communicating with a call center or the like. Once the cancellation protocol has been received by the device the alert will be cancelled and the device will enter either Open Mode or Ready Mode.

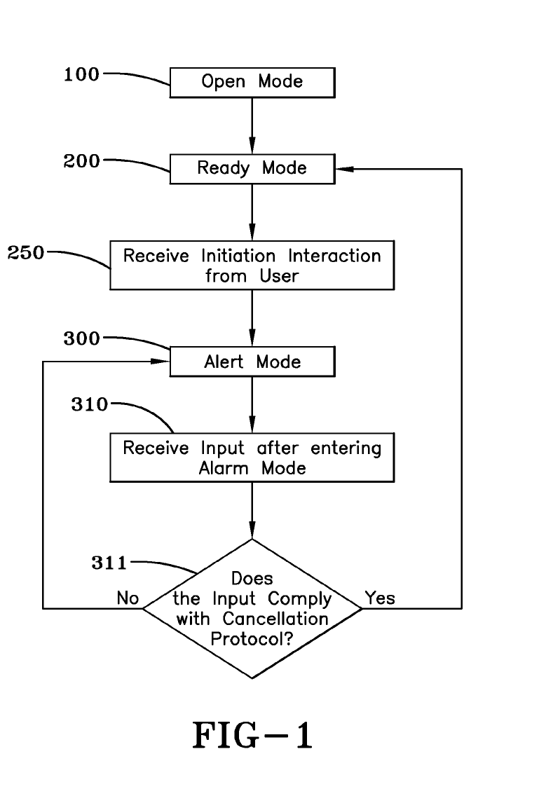

FIG. 1 shows a flow chart demonstrating the functionality of the described methods. In an embodiment, the method has an Open Mode 100 which may be activated by selecting an icon displayed on a mobile telecommunications device. Once opened, a user may prompt the method to start a Ready Mode 200, while in Ready Mode, the mobile telecommunications device displays an interaction icon such as is enabled to receive an Initiation Interaction from a user, should this take place then an Alarm Mode 300 is initiated. Once the device enters an alarm mode several functions are initiated which will be discussed below. After an alert has been triggered the device is still capable of receiving input from a user, the device receives this post-triggering input 310 and if the input meets a cancellation protocol 311 then the Alarm Mode may be cancelled and the device will then return to Ready Mode.

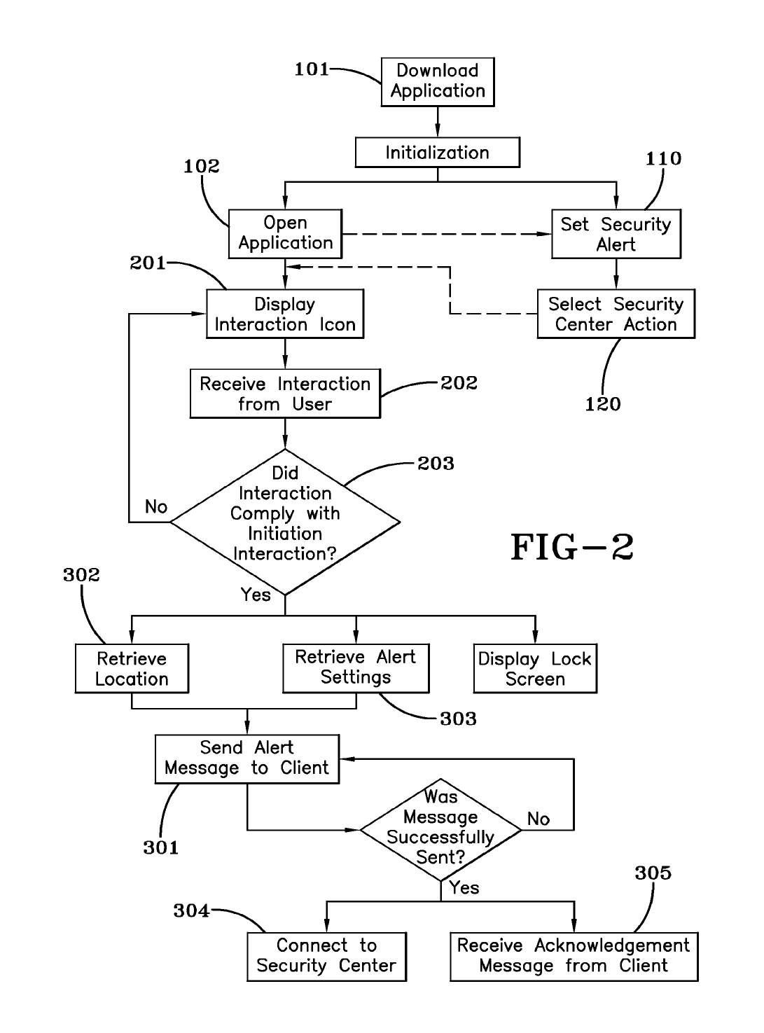

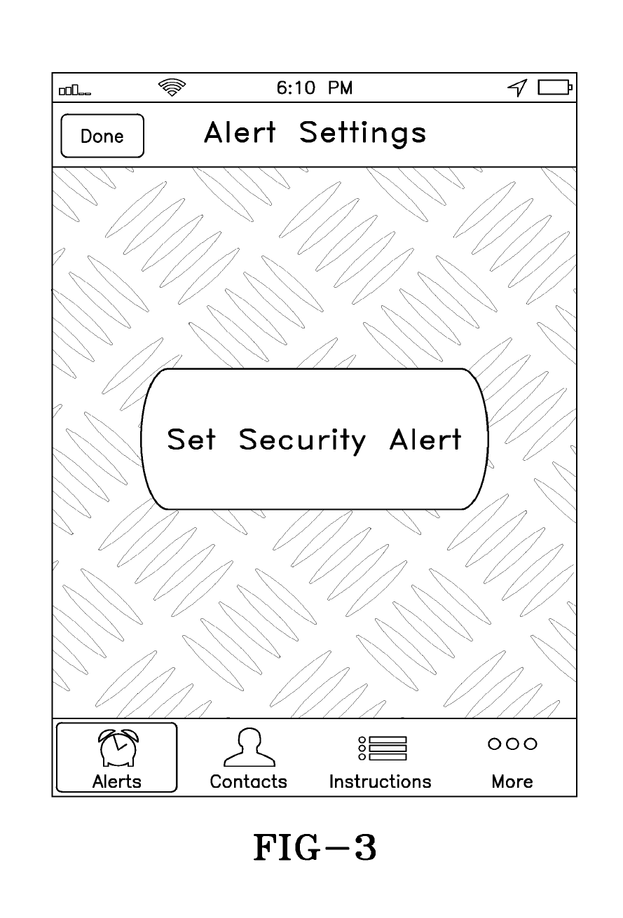

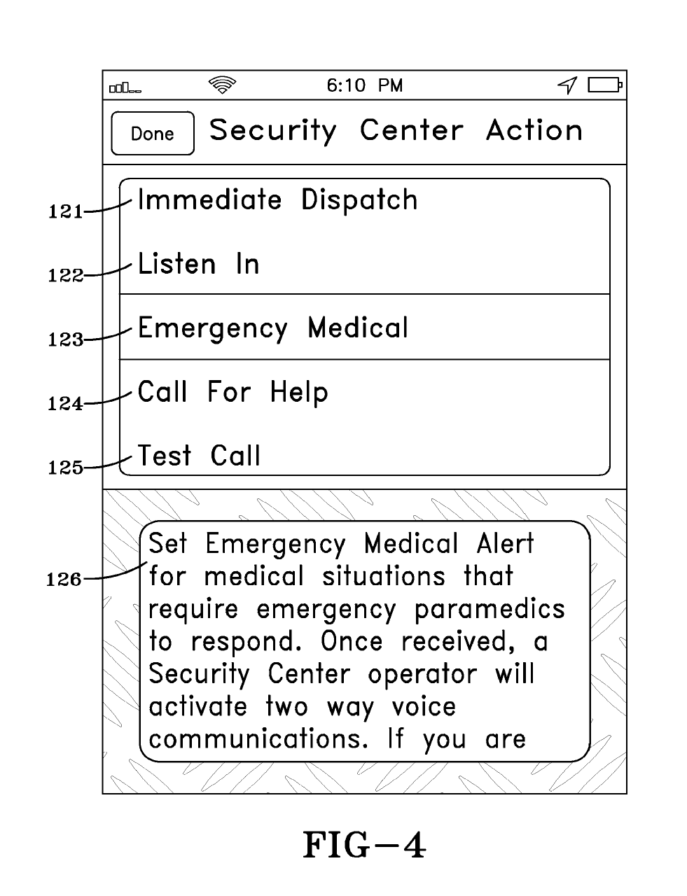

FIG. 2 shows a flow chart representing functionality of the described methods. Once started, the application enters an Open Mode. The user may then be prompted to set security alert 110, an embodiment of a prompt to select or set security alert is shown in FIG. 3. This prompt may be a touch screen button allowing the user to tap the screen to open up an Alert Settings selection menu. Should the user select the set security alert prompt; the user is then directed to a menu to select a security center action 120. The term “security center action” as used herein describes the instructions that the user would like communicated to the security center should an initiation interaction be received by the mobile telecommunications device. FIG. 4 shows a possible list of security center actions. In the embodiment shown in FIG. 4, the security center actions include: Immediate Dispatch 121, Listen In 122, Emergency medical 123, Call For Help 124 and Test Call 125. In an embodiment, the security center action menu may provide instructions 126 for the most appropriate selection for the user's particular needs. The method may enable the display of the instructions as the user scrolls down the menu prior to selection, or alternatively, the instructions may be displayed upon touch screen selection in a validation manner, letting the user verify whether or not their selection is appropriate.

Immediate Dispatch represents an option for instructing the security center to immediately dispatch the police to the location of the mobile telecommunications device, in an embodiment this prioritizes the signal at the security center to that of a bank robbery, where it is a top priority.

The Listen In selection instructs the security center to listen and determine the seriousness of any disturbances that might be occurring via the audio sent via the mobile telecommunications device's microphone. This selection may instruct the security center not to contact the user until it has been determined that no emergency is occurring. Alternatively, this function may allow the security center to instruct the mobile telecommunications device to prompt the user for additional information via silent or touch screen “buttons” to determine the extent of danger that the user is in. This function might allow a user to keep their mobile telecommunications device hidden (in a pocket for example) and covertly communicate to the security center that they are being accosted or the like.

Emergency Medical selection instructs the security center to contact, for example, the nearest ambulance dispatch center and instructs the dispatcher to send help to the location of the mobile telecommunications device. Alternatively, this function opens up a two-way communication connection allowing the security center to analyze and prioritize the necessary action. Once again, emergency responders are not equipped to respond to GPS signal coordinates, thus the method and computer implemented application send the GPS location to the security center and the GPS coordinates are translated to a physical address (with associated distance error) to which the emergency responder is able to respond. This selection might be particularly helpful to the elderly or the infirm—they are more likely to need emergency medical attention due to their diminished health status and thus a selection requesting, for example, Immediate Dispatch would not be appropriate for the most likely scenario they may find themselves in.

Call For Help selection allows the user to create a “call list” of numbers for the security center to contact in the event of an Initiation Interaction (presumably prompted by a dangerous situation). The security center will then, once an event has been signaled, contact the numbers on the call list in order to apprise the persons on the list that an event has happened involving the user and convey the location of the mobile telecommunications device. This is analogous to an emergency contact often required of participants in for example 5 k charity runs, except that the present method allows for more than one number and may allow for personalized messages to be delivered by the security center. In an embodiment, the method allows the user to send a predetermined message to the numbers on the call list. Initiates two-way voice communication with the security center allowing the security center to communicate the nature of the situation that the user finds themselves in, to the persons on the call list.

Test Call is a selection allowing the user to contact the security center upon first activating the application. The Test Call also functions to reinforce to the user, the speed of the response of the security center.

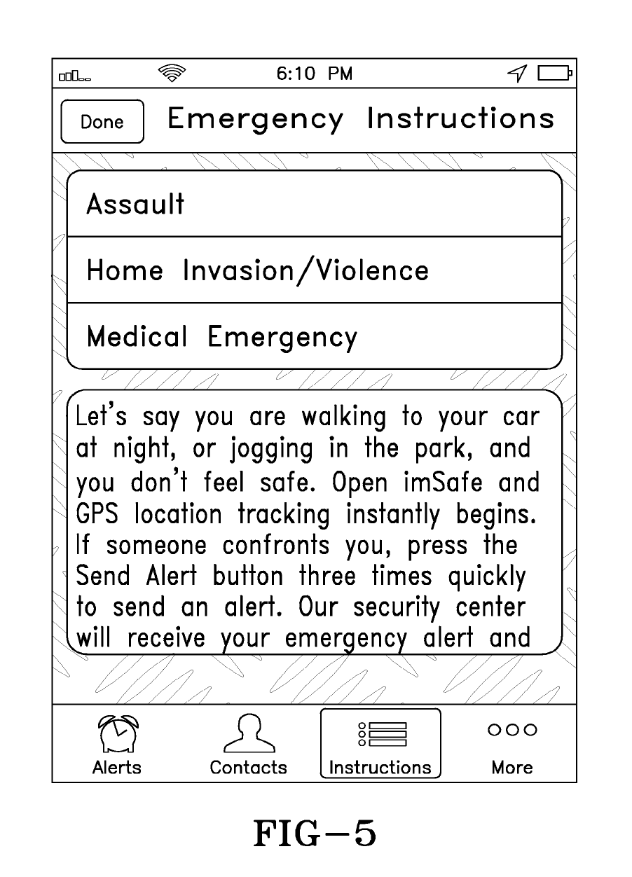

Optionally, the application may include Emergency Instructions. FIG. 5 is a screenshot of an embodiment of emergency instructions. The emergency instructions include several categories of emergencies. The categories may include: Assault, Home Invasion/Violence, and Medical Emergency. Unique instructions are associated with each category and may be displayed as the user scrolls from one category to another with their mobile telecommunications device. The emergency instructions provide context for users about what the method does and which security center alert is most appropriate for different scenarios and also offers instructions on how to operate the application.

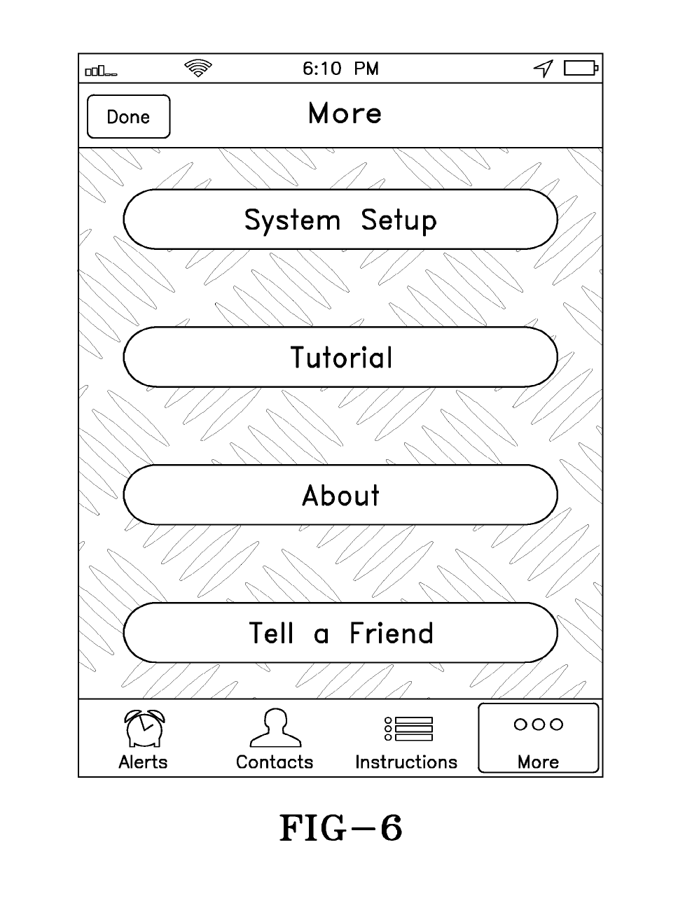

FIG. 6 is a screenshot showing a menu of additional features that an exemplary application may have. The menu includes selections for System Setup, Tutorial, About, and an option for Tell A Friend.

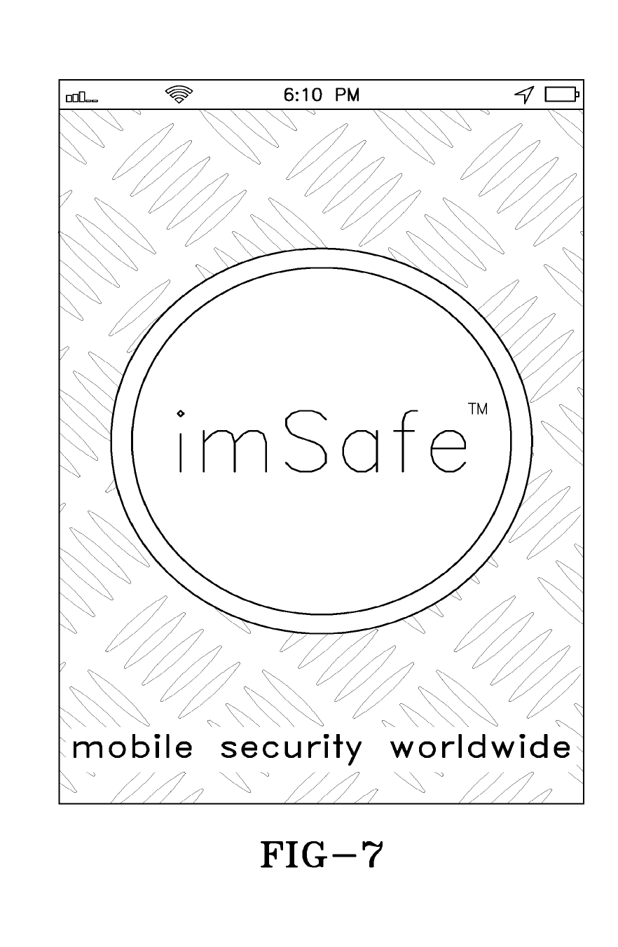

FIG. 7 is a screenshot of an embodiment of an interaction icon.

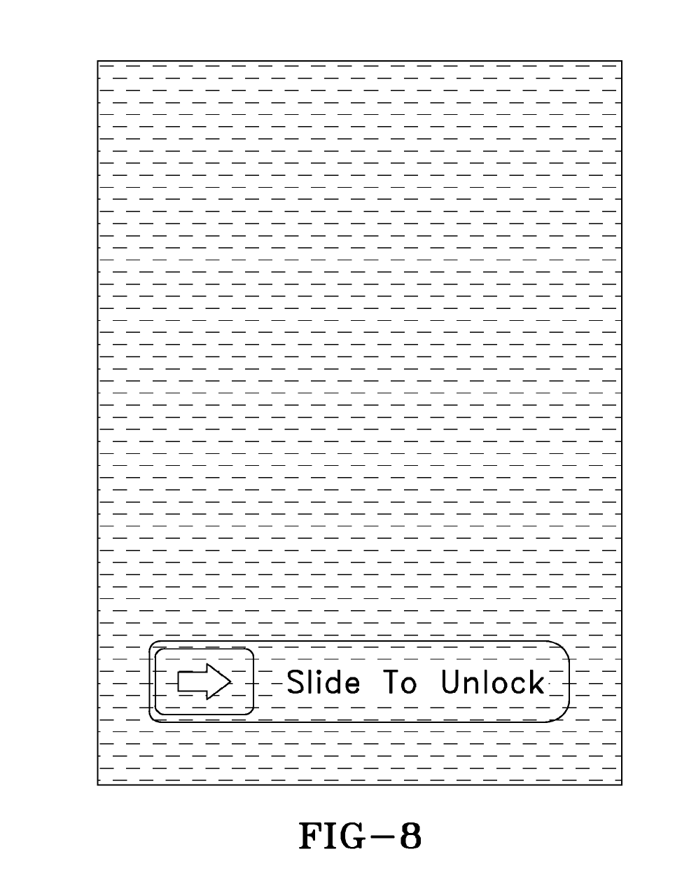

FIG. 8 is a screenshot of an embodiment of a screen in a locked mode.

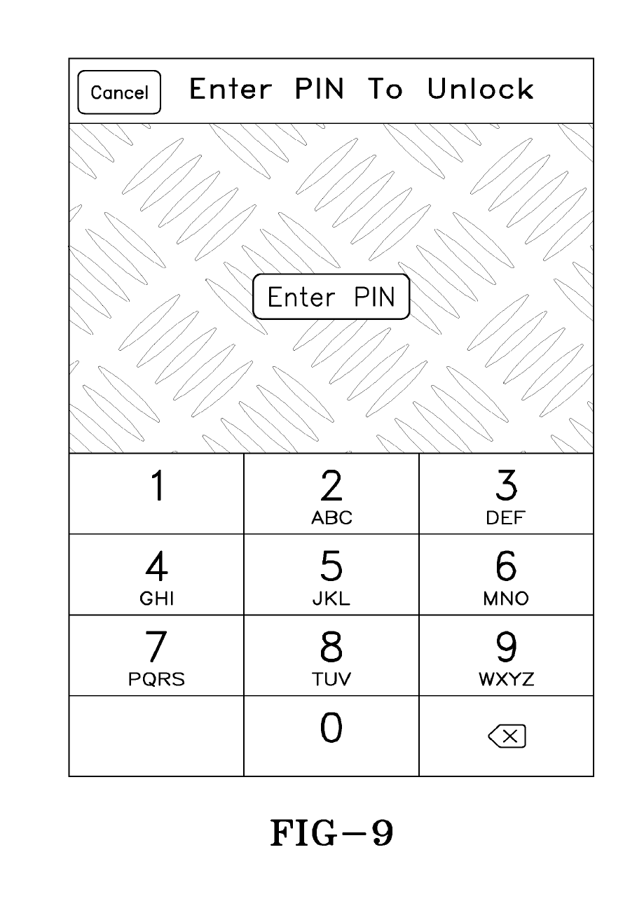

FIG. 9 is a screenshot of an embodiment of a PIN screen.

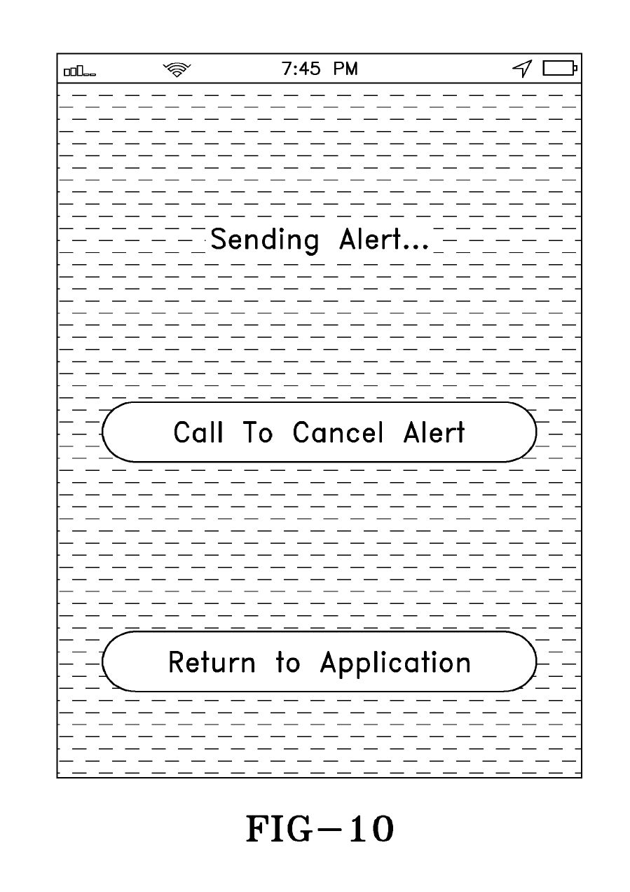

FIG. 10 is a screenshot showing options to the user after a PIN has been entered. In an embodiment, after a PIN has been entered in the application, a menu with options including Call to Cancel Alert and Return To Application may be displayed. These options may be accessed after an initiation interaction has been received by the mobile telecommunications device and the mobile telecommunications device has entered Alert Mode. The user may then access a PIN screen after unlocking the device. Once the PIN has been entered, the user may select from the menu. In an embodiment, the Call to Cancel Alert selection connects the mobile telecommunications device to a security center and allows the user to cancel the alert and return the mobile telecommunications device to either Ready Mode or Open Mode. The Return To Application selection will exit from the present menu and return the mobile telecommunications device to Ready Mode or Open Mode.

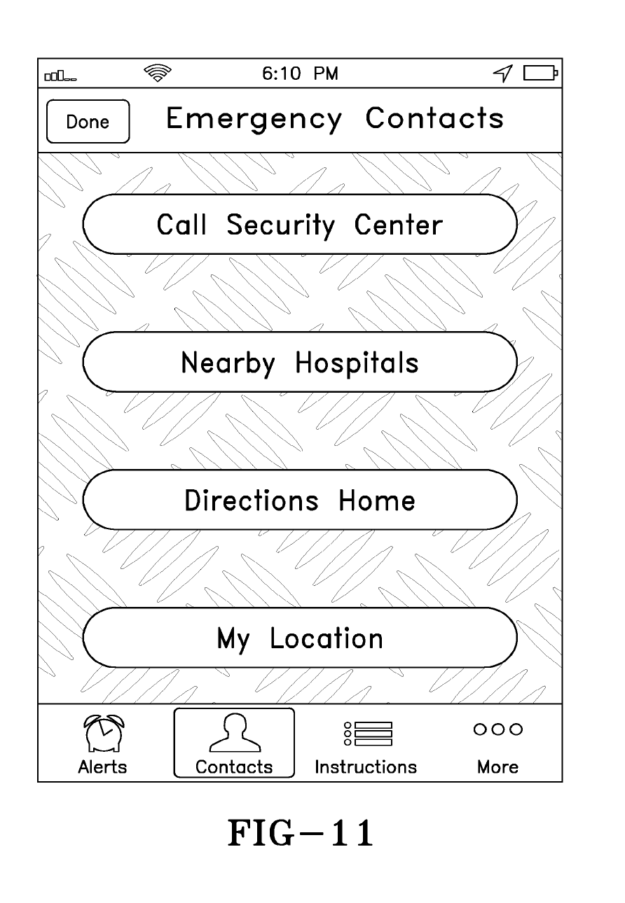

FIG. 11 is a screenshot of a menu of Emergency Contacts. Emergency contacts include selectable options each with unique functions. The Call Security Center option will connect the mobile telecommunications device to a security center for two-way communication. The Nearby Hospitals selection will cause the mobile telecommunications device to display information regarding nearby hospitals, the information may include phone numbers, addresses and/or an interactive map showing a predetermined number of nearby hospitals based on a predetermined radius from the current location of the mobile telecommunications device. In an embodiment, the nearby hospitals selection accesses an interactive map from the internet such as Google Maps.

Returning to FIG. 2, a timeline of events describing use of the method and an application which performs the method will now be described. This timeline and the associated FIG. 2 are not intended to represent the only path of performing the method but are merely illustrative of the steps comprising the method.

A mobile telecommunications device downloads an application 101. The application upon installing on the mobile telecommunications device, initiates the computer implemented method 102 and allows the user to Set Security Alert. The application may prompt the user to set the alert or may include a default Alert Setting and merely allow the user to select to Set Security Alert at the user's convenience. The Alert Settings, whether default or selected by the user comprise Security Center Actions. The Security Center Actions may be displayed for the user with helpful instructions or scenarios illustrating their applicability displayed upon highlighting each selection.

After downloading and initialization of the application; the user may find themselves in a location or state of affairs where they suspect that an emergency situation is likely. This could include walking to the user's car after dark, traveling in a strange area, the user has a serious medical condition, or perhaps the user simply feels more secure with an alert mechanism nearby. Whatever the scenario, the user would then open the application. Upon opening, the user may then instruct the application to enter Ready Mode and display an interaction icon 201. The icon may be a touch screen “button” or other selectable icon. In an embodiment, the interaction icon is a button and includes instructions for initiating an Alert, such as “tap 3 times” or “slide finger across screen.” Should the user then find themselves in a dangerous situation they can then perform an initiation interaction 202. In an embodiment, the initiation interaction comprises tapping the screen 3 times in succession within a predetermined amount of time such as 2 seconds. The method then determines if the user has complied with the predetermined Initiation Interaction (shown as 203). If the user fails to comply with the initiation interaction, the application deems the interaction a false alarm and returns to Ready Mode—without entering Alert Mode—displaying the interaction icon. If the user complies with the initiation interaction, the application enters an Alert Mode and follows the instructions that the user selected upon initialization—the Alert Setting or the default alert setting. The application will direct the mobile telecommunications device to send a first message 301 (alternatively referred to as an alert message) to a remote client informing the client of the initiation interaction and corresponding alert. The message will include the current position 302 of the mobile telecommunications device as determined by the mobile telecommunications device and the instructions commensurate with the Alert Setting 303 that was selected by the user (or the default if the user has yet to make a selection).

Once the device has received an initiation interaction and sent to the client the device will then provide feedback to the user that the message has been sent. The feedback may be in the form of a brief vibration pulse or the like. Alternatively, the client may then return an acknowledgement message acknowledging receipt of the alert message and location. Once the device has sent the message and/or received an acknowledgement message it may then provide an audible or silent communication to the user that the message has been sent/received at the client. The communication may be a short vibration pulse or the like.

Once the client successfully receives the Alert Message 301 from the device it will send a message to a security center with the identity of the user, the location received from the device and instructions for communication or dispatching emergency services (the security center action).

Once an initiation interaction has been received by the mobile communications device Alert Mode is entered. The device sends a current location to a client and the device continues to monitor the current location of the device. Should the device be moved more than a preset distance (for example 10 meters, 50 feet etc.) from the location where the initiation interaction was received, a second message will be sent to the client regardless of the Alert Setting selected by the user. This process will be repeated every time the device travels a predetermined distance from the most recent location. This constant location updating is particularly useful should a user find themselves in a scenario such as: an abduction or fleeing a dangerous situation etc. The location updating will continue until Alert mode is cancelled or the device ceases to travel more than the predetermined distance from the last location report.

Once an initiation interaction has been received the method will cause the mobile telecommunications device to display a lock screen. The lock screen may require a user to perform a task in order to unlock the device. The task may include sliding a finger across the screen in a predetermined location, selecting an icon with a track-ball, speaking an audible command or the like. Should the appropriate task be performed, the device may then display a personal identification number or PIN screen. The PIN screen requires a user to input a PIN. Should the device receive the PIN input from a user, the device may then provide options for cancelling Alert Mode, contacting the security center directly, exiting the application, entering Open Mode, accessing other options in the application or reentering Ready Mode etc.

In an embodiment, the computer implemented method allows a user to interact with the security system of a structure such as a home security system via the mobile telecommunications device. The method may allow access to icons after entering Alert Mode granting access to a home security system to start an audible alarm or contact the home security system call center or the like. Or the method may grant access prior to entering Alert Mode such as by displaying two icons on a touch screen of the device allowing a user to select either performing an initiation interaction or simply initiating the structural alarm.

In an embodiment, the method also comprises the ability to connect a user to non-emergency services. Such services may include an option to display the current location of the device, display nearby hospitals, direction home etc. Optionally, when one of the above options is selected the method displays a web-enabled internet map like that available under the name GoogleMap. The display nearby hospitals may display the locations of nearby hospitals on map and may have the options to select an icon representing the hospital and provide directions to the selected hospital either in text form, highlighted map or both—this same function would be available for a directions home option or current location option.

Optionally, the method provides a user with concierge services, which provide contact with the security center in a non-emergency setting such as for obtaining directions from a security center or a request to send first responder assistance after an automobile accident. This option may be accessible as part of an alternative alert mode. That is, this mode may be accessed by performing an initiation interaction but the user is directed to the security center directly along with the transmission of GPS/cellular triangulation location.

The terms “a” and “an” and “the” and similar references used in the context of describing the disclosed embodiments (especially in the context of the following claims) are to be construed to cover both the singular and the plural, unless otherwise indicated herein or clearly contradicted by context.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein is intended merely to better illuminate the disclosed embodiments and does not pose a limitation on the scope of the disclosed embodiments unless otherwise claimed. No language in the specification should be construed as indicating any non-claimed element essential to the practice of the disclosed embodiments or any variants thereof.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability

Preferred embodiments of this invention are described herein, including the best mode known to the inventors for carrying out the invention(s). Of course, variations on the disclosed embodiments will become apparent to those of ordinary skill in the art upon reading the foregoing description. The inventors expect(s) skilled artisans to employ such variations as appropriate, and the inventors intend(s) for the invention(s) to be practiced otherwise than specifically described herein. Accordingly, this disclosure includes all modifications and equivalents of the subject matter recited in the claims appended hereto as permitted by applicable law. Moreover, any combination of the above described elements in all possible variations thereof is encompassed by the disclosed embodiments unless otherwise indicated herein or otherwise clearly contradicted by context.

Having shown and described an embodiment of the invention, those skilled in the art will realize that many variations and modifications may be made to affect the described invention and still be within the scope of the claimed invention. Additionally, many of the elements indicated above may be altered or replaced by different elements which will provide the same result and fall within the spirit of the claimed invention. It is the intention, therefore, to limit the invention only as indicated by the scope of the claims.

What is claimed is:

1. A personal emergency notification method comprising:
determining if user input to a mobile device corresponds to a predetermined user input condition representing an emergency situation;
if said user input corresponds to said predetermined user input condition: automatically generating a message on the mobile device, the message including information regarding the emergency situation;
automatically transmitting the message to a remote call center over a communications network for processing of the information.

2. The method of claim 1, wherein the communications network is selected from the group comprising: the Internet, a cellular network, and combinations thereof.

3. The method of claim 1, wherein the information regarding the emergency situation includes, an identity of the mobile device, a current location of the mobile device, and an alert setting of the mobile device.

4. The method of claim 1, further comprising determining if the mobile device has moved more than a predetermined distance from an initial location of the mobile device where the predetermined user input condition was met; if said mobile device has moved more than said predetermined distance:
automatically generating a second message on the mobile device, the message including the current location of the mobile device; and
automatically sending the second message to the remote call center.

5. The method of claim 1, wherein the predetermined user input condition includes the user tapping a touch screen of the mobile device a predefined number of times within a set time period.

6. The method of claim 5, wherein predetermined the user input condition requires that the tapping occur within a predefined area of the touch screen.

7. The method of claim 5, wherein the predetermined user input condition comprises tapping a touch screen of the mobile device three times within two seconds.

8. The method of claim 7, wherein the predefined user input condition requires that the tapping occur within a predetermined area of the touch screen.

9. The method of claim 7, further comprising automatically displaying a lock screen on the device if the predetermined user input condition is met.

10. The method of claim 1, further comprising automatically displaying a lock screen on the device if the predetermined user input condition is met.

11. The method of claim 10, further comprising determining if user input to the mobile device corresponds to a second predetermined user input condition for initiating an unlock protocol, after the lock screen is displayed.

12. The method of claim 11, wherein the unlock protocol is completed by one of: entering a password on the touch screen, providing an audible command to the mobile device, entering a touch sequence on the touch screen, or selecting an icon displayed on the screen.

13. The method of claim 1, further comprising the step of automatically generating a notification to the user on the mobile device immediately after successful transmission of the message.

14. The method of claim 13, further comprising automatically displaying a lock screen on the mobile device if the predetermined user input condition is met.

15. The method of claim 14, further comprising determining if second user input to the mobile device corresponds to a second predetermined user input condition for initiating an unlock protocol, after the lock screen is displayed.

16. The method of claim 15, wherein the unlock protocol is completed by one of: entering a password on the touch screen, providing an audible command to the mobile device, entering a touch sequence on the touch screen, or selecting an icon displayed on the touch screen.

17. The method of claim 13, wherein the notification is an audible alert, a visual alert, a tactile alert and combinations thereof.

18. The method of claim 17, wherein the notification is tactile and includes at least one vibrational pulse.

19. A personal emergency notification method comprising:
determining if user input to a mobile device corresponds to a predetermined user input condition representing an emergency situation, the predetermined user input condition includes the user tapping a predefined area of a touch screen of the device a predefined number of times during a set time period;
if said user input corresponds to said predetermined user input condition, automatically generating a message on the mobile device, the message including information regarding the emergency situation, the information on the emergency situation comprises: identity of the device, a current location of the device, and an alert setting of the device;
automatically transmitting the message to a remote call center over a communications network for processing of the information;
automatically generating a notification to the user on the mobile device immediately after successful transmission of the message, wherein the notification is an audible alert, a visual alert, a tactile alert and combinations thereof;
automatically displaying a lock screen on the device;
determining if second user input to the mobile device corresponds to a second predetermined user input condition for initiating an unlock protocol, after the lock screen is displayed.

20. The method of claim 19, further comprising the step of unlocking the device if user input to the mobile device corresponds to a second predetermined user input condition representing an unlock protocol.
